(19) United States
(12) Patent Application Publication
(10) Pub. No.: US 2016/0319112 A1
(43) Pub. Date: Nov. 3, 2016

(54) ELASTOMERIC COMPOSITION HAVING AN IMPROVED FILLER DISPERSION

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Perrine VALLAT, Clermont-Ferrand (FR); Isabelle ALDON, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/105,805

(22) PCT Filed: Dec. 12, 2014
(86) PCT No.: PCT/EP2014/077583

§ 371 Date: Jun. 17, 2016

(30) Foreign Application Priority Data
Dec. 20, 2013 (FR) 1363144

(51) Int. Cl. C08L 7/02; C08J 3/22

(52) U.S. Cl. CPC C08L 7/02; C08J 3/226; C08L 2205/06; C08L 2310/00; C08J 2307/02; C08J 2409/00

(57) ABSTRACT

A rubber composition based on at least one first diene elastomer, a reinforcing filler comprising at least carbon black and an inorganic filler with an inorganic filler content of less than or equal to 50 parts by weight per hundred parts of elastomer is provided. The composition is obtained from a first masterbatch comprising at least the first diene elastomer and carbon black, and having a dispersion of the carbon black in the elastomeric matrix that has a Z value of greater than or equal to 90, added to which is the inorganic filler and at least one second elastomer consisting of a polyisoprene.

This application is a 371 national phase entry of PCT/EP2014/077583, filed 12 Dec. 2014, which claims benefit of French Patent Application No. 1363144, filed 20 Dec. 2013, the entire contents of which are incorporated herein by reference for all purposes.

### BACKGROUND

1. Technical Field

The invention relates to a rubber composition based on at least one inorganic filler, in particular silica, and on a masterbatch based on diene elastomer and carbon black, said masterbatch having a very good dispersion of the carbon black in the elastomeric matrix, and the composition having a good dispersion of all of its filler of the composition in its elastomeric matrix.

The term “masterbatch” is understood to mean: an elastomer-based composite into which a filler and optionally other additives have been introduced.

The present invention relates in particular to the use of such a masterbatch for the manufacture of diene rubber compositions reinforced with a blend of organic filler and inorganic filler, which are intended for the manufacture of tires or of semi-finished products for tires, in particular treads for these tires.

2. Related Art

It is known that in order to obtain the optimum reinforcing properties and hysteresis properties imparted by a filler to a tire tread, and thus to obtain high wear resistance and low rolling resistance, it is generally advisable for this filler to be present in the elastomeric matrix in a final form that is both as finely divided as possible and as uniformly distributed as possible. However, such conditions can be achieved only if this filler has a very good capacity, on the one hand, to be incorporated into the matrix during the mixing with the elastomer and to deagglomerate, and, on the other hand, to disperse uniformly in this matrix.

Since fuel savings and the need to protect the environment have become a priority, it has proved necessary to produce tires that have a reduced rolling resistance without adversely affecting their wear resistance.

This has been made possible in particular by virtue of the use, in the treads of these tires, of novel rubber compositions reinforced at least partially with inorganic fillers, in particular specific silicas of the highly dispersible type, that are capable of rivalling from the reinforcing standpoint a conventional tire-grade carbon black, while offering these compositions a lower hysteresis, which is synonymous with a lower rolling resistance for tires containing them, and also improved grip on wet, snow-covered or icy ground.

However, for reciprocal affinity reasons, these inorganic filler particles have an annoying tendency to clump together in the elastomeric matrix. These interactions have the deleterious consequence of limiting the dispersion of the filler and therefore the reinforcing properties to a level substantially below that which would be theoretically possible to achieve if all the (inorganic filler/elastomer) bonds capable of being created during the compounding operation were actually obtained. These interactions moreover tend to increase the viscosity in the uncured state of the rubber compositions and therefore to make them more difficult to process than when carbon black is present, even for highly dispersible silicas.

There are various methods for obtaining a masterbatch of diene elastomer and reinforcing filler. In particular, one type of solution consists, in order to improve the dispersibility of the filler in the elastomeric matrix, in compounding the elastomer and the filler in the “liquid” phase. To do so, the process involves an elastomer in latex form, which is in the form of water-dispersed elastomer particles, and an aqueous dispersion of the filler, that is to say a filler dispersed in water, commonly referred to as a “slurry”. Certain processes in particular, such as those described in document U.S. Pat. No. 6,048,923, make it possible to obtain a masterbatch of elastomer and filler that has a very good dispersion of the filler in the elastomeric matrix, greatly improved compared to the dispersion of the filler in the elastomeric matrix capable of being obtained during the solid-phase compounding of elastomer and reinforcing filler. This process consists in particular in incorporating a continuous flow of a first fluid consisting of an elastomer latex into the compounding zone of a coagulation reactor, in incorporating a second continuous flow of a second fluid consisting of an aqueous dispersion of filler under pressure into the compounding zone to form a mixture with the elastomer latex, the compounding of these two fluids being sufficiently energetic to make it possible to almost completely coagulate the elastomer latex with the filler before the outlet orifice of the coagulation reactor, and then in drying the coagulum obtained.

This process is particularly suitable for producing a masterbatch that has a very good dispersion, starting from a natural rubber latex and carbon black. Indeed, the application of this process is rendered particularly favourable by the ability that the natural rubber latex and carbon black have to coagulate together spontaneously. Conversely, silica does not coagulate spontaneously with the natural rubber latex since the silica aggregates are typically hydrophilic in nature and have greater affinity with water than with the elastomer particles themselves.

Furthermore, such a process has a limit as regards the content of carbon black present in the masterbatch, however the subsequent incorporation of carbon black in solid form, to increase the overall filler content in the elastomeric matrix, does not make it possible to retain the advantages obtained for the hysteresis. Moreover, this process is also limited in practice, as regards the type of diene elastomer that can be used in order to have a combined coagulation of the carbon black and of the elastomer, to natural rubber; however the advantage of using other elastomers for many tire applications has been known for a long time.

### SUMMARY

The applicant had surprisingly discovered in its patent application WO 2012/080109 that, contrary to the effect of the addition of carbon black in solid form and of a second elastomer, identical to or different from the first, and contrary to the knowledge of those skilled in the art regarding the difficulties in dispersing and processing silica in an elastomeric matrix, the incorporation of silica and of a second elastomer into a diene elastomer and carbon black masterbatch that has a very good dispersion of the carbon black in the diene elastomer matrix, especially masterbatches prepared according to the aforementioned process, made it possible to obtain compositions having improved hysteresis while retaining a good dispersion of all of the filler in the elastomeric matrix then consisting of two elastomers.

The applicant has continued its research and has discovered that when the second diene elastomer added is a polyisoprene, the composition obtained has much better limiting properties at break than when another elastomer is added, contrary to what could be expected by a person skilled in the art, especially considering the various glass transition temperatures of these elastomers.

One subject of the invention is thus a rubber composition based on at least one first diene elastomer, a reinforcing filler comprising at least carbon black and an inorganic filler with an inorganic filler content of less than or equal to 50 parts by weight per hundred parts of elastomer, characterized in that the composition is obtained from a first masterbatch comprising at least the first diene elastomer and carbon black, and having a dispersion of the carbon black in the elastomeric matrix that has a Z value of greater than or equal to 90, added to which is the inorganic filler and at least one second elastomer consisting of a polyisoprene.

According to one embodiment variant of the invention, the first masterbatch is obtained by liquid-phase compounding starting from a latex of the diene elastomer and an aqueous dispersion of carbon black, in particular according to the following process steps:
feeding a continuous flow of the latex of the first diene elastomer to a mixing zone of a coagulation reactor defining an elongate coagulation zone extending between the mixing zone and an outlet,
feeding a continuous flow of a fluid comprising a filler under pressure to the mixing zone of a coagulation reactor to form a coagulated mixture,
drying the coagulum obtained above in order to recover the first masterbatch.

Advantageously, the weight fraction of the first diene elastomer in the elastomeric matrix of the composition is greater than or equal to 60%, and preferably greater than or equal to 80%.

Preferably, the first diene elastomer is selected from the group consisting of polybutadienes, natural rubber, synthetic polyisoprenes, butadiene copolymers, isoprene copolymers and blends of these elastomers, and even more preferably it is a natural rubber.

According to one embodiment variant of the invention, the inorganic filler is a silica or a silica-covered carbon black, preferably it is a precipitated silica.

The invention also relates to a process for obtaining a composition based on at least one first diene elastomer and a second elastomer consisting of a polyisoprene, a reinforcing filler comprising at least carbon black and an inorganic filler with an inorganic filler content of less than or equal to 50 parts by weight per hundred parts of elastomer, which comprises the following steps:
preparing a first masterbatch comprising the diene elastomer and the carbon black, this first masterbatch having a dispersion of the reinforcing filler in the elastomeric matrix that has a Z value greater than or equal to 90,
incorporating the inorganic filler, the second elastomer and the other constituents of the composition, with the exception of the crosslinking system, into the first masterbatch in a mixer, everything being kneaded thermomechanically until a maximum temperature of between 130° C. and 200° C. is reached,
cooling the combined mixture to a temperature below 100° C.,
subsequently incorporating: the crosslinking system,
kneading everything up to a maximum temperature below 120° C.

A final subject of the invention is a finished or semi-finished article, a tire tread, a tire or a semi-finished product comprising a composition as described previously.

### MEASUREMENTS AND TESTS

The rubber compositions are characterized, before and after curing, as indicated below.

Dispersion

As is known, the dispersion of filler in an elastomeric matrix can be represented by the Z value, which is measured, after crosslinking, according to the method described by S. Otto et al. in Kautschuk Gummi Kunststoffe, 58th edition, NR 7-8/2005, in agreement with the standard ISO 11345.

The calculation of the Z value is based on the percentage of surface area in which the filler is not dispersed (“% undispersed surface area”), as measured by the “disperGRADER+” machine provided with its operating process and its “disperDATA” operating software by the company Dynisco according to the equation:

Z=100−(% undispersed surface area)/0.35

The percentage of undispersed surface area is, itself, measured by a camera that observes the surface area of the sample under incident light at 30°. The light points are associated with the filler and agglomerates, whilst the dark points are associated with the rubber matrix; digital processing converts the image into a black and white image, and enables the determination of the percentage of undispersed surface area, as described by S. Otto in the aforementioned document.

The higher the Z value, the better the dispersion of the filler in the elastomeric matrix (a Z value of 100 corresponding to a perfect dispersion and a Z value of 0 to a mediocre dispersion). A Z value greater than or equal to 80 will be considered to correspond to a surface area having a very good dispersion of the filler in the elastomeric matrix.

Tensile Tests

These tensile tests make it possible to determine the elasticity stresses and the properties at break. Unless otherwise indicated, they are carried out in accordance with the French standard NF T 46-002 of September 1988. At second elongation (i.e. after an accommodation cycle at the extension rate provided for the measurement itself) the nominal secant modulus (or apparent stress, in MPa) is measured at 100% elongation (denoted by MA100). The tensile measurements for determining the secant accommodated moduli are carried out at a temperature of 23° C.-2° C., and under standard hygrometry conditions (50%-5% relative humidity).

The stresses at break (in MPa) and elongations at break (in %) are also measured. All these tensile measurements are carried out at a temperature of 60° C.-2° C., and under standard hygrometry conditions (50% -5% relative humidity), according to the French standard NF T 40-101 (December 1979).

Dynamic Properties

The dynamic properties and in particular tan(d)ₘₐₓ, representative of the hysteresis, are measured on a viscosity analyser (Metravib VA4000), according to the standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded under standard temperature conditions (23° C.) according to the standard ASTM D 1349-99, or, depending on the case, at a different temperature; in particular in the examples cited, the measurement temperature is 60° C. A peak-to-peak strain amplitude sweep is carried out from 0.1% to 50% (forward cycle) and then from 50% to 0.1% (return cycle). The results made use of are the complex dynamic shear modulus (G*) and the loss factor tan(d). For the return cycle, the maximum value of tan(d) observed, denoted by tan(d)ₘₐₓ, is indicated.

Tearability

The tearability indices are measured at 100° C. In particular, the force to be exerted in order to obtain the break (FRD, in MPa (in N/mm)) is determined and the strain at break (DRD, in %) is measured on a test specimen with dimensions of 10×105×2.5 mm that is notched in the centre of its length by 3 notches to a depth of 5 mm in order to give rise to the break of the test specimen.

### DETAILED DESCRIPTION OF EXAMPLE EMBODIMENTS

Embodiments of the invention relate to a composition based on at least one first diene elastomer, a reinforcing filler comprising at least carbon black and an inorganic filler with an inorganic filler content of less than or equal to 50 parts by weight per hundred parts of elastomer, this composition being obtained from a first masterbatch comprising at least the first diene elastomer and carbon black, and having a dispersion of the carbon black in the elastomeric matrix that has a Z value of greater than or equal to 90, added to which is the inorganic filler and at least one second elastomer consisting of a polyisoprene.

It will be noted that in the concept of phr: “parts by weight per hundred parts of elastomer”, the whole of all of the elastomers present in the final composition is taken into consideration.

In the present description, unless expressly indicated otherwise, all the percentages (%) shown are % by weight. Furthermore, any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

1) Elastomer

As is customary, the terms “elastomer” and “rubber”, which are interchangeable, are used without distinction in the text.

The composition in accordance with embodiments of the invention comprises at least one first diene elastomer and a second elastomer consisting of a polyisoprene.

A “diene” elastomer or rubber should be understood, in a known manner, to mean an elastomer resulting at least in part (i.e., a homopolymer or a copolymer) from diene monomers (monomers bearing two carbon-carbon double bonds which may or may not be conjugated).

These diene elastomers can be classified into two categories: “essentially unsaturated” or “essentially saturated”. Generally, the expression “essentially unsaturated” is understood to mean a diene elastomer resulting at least in part from conjugated diene monomers having a content of units of diene origin (conjugated dienes) which is greater than 15% (mol %); thus it is that diene elastomers such as butyl rubbers or diene/α-olefin copolymers of the EPDM type do not fall under the preceding definition and may especially be described as “essentially saturated” diene elastomers (low or very low content of units of diene origin, always less than 15%). In the category of “essentially unsaturated” diene elastomers, the expression “highly unsaturated” diene elastomer is understood to mean in particular a diene elastomer having a content of units of diene origin (conjugated dienes) which is greater than 50%.

Among these diene elastomers, natural rubber and synthetic elastomers are furthermore distinguished.

By synthetic diene elastomers capable of being used, the expression “diene elastomer” is understood more particularly to mean:

(a)-any homopolymer obtained by polymerization of a conjugated diene monomer having from 4 to 12 carbon atoms;

(b)-any copolymer obtained by copolymerization of one or more conjugated dienes with one another or with one or more vinylaromatic compounds having from 8 to 20 carbon atoms;

(c)-a ternary copolymer obtained by copolymerization of ethylene and of an α-olefin having from 3 to 6 carbon atoms with an unconjugated diene monomer having from 6 to 12 carbon atoms, such as, for example, the elastomers obtained from ethylene and propylene with an unconjugated diene monomer of the aforementioned type, such as, in particular, 1,4-hexadiene, ethylidene norbornene or dicyclopentadiene; and

(d)-a copolymer of isobutene and of isoprene (butyl rubber) and also the halogenated versions, in particular chlorinated or brominated versions, of this type of copolymer.

The following are suitable in particular as conjugated dienes: 1,3-butadiene, 2-methyl-1,3-butadiene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta-or para-methylstyrene, the commercial “vinyl-toluene” mixture, para-(tert-butyl)styrene, methoxystyrenes, chlorostyrenes, vinylmesitylene, divinylbenzene or vinylnaphthalene.

The copolymers may contain between 99% and 20% by weight of diene units and between 1% and 80% by weight of vinylaromatic units. The elastomers may have any microstructure, which depends on the polymerization conditions used, in particular on the presence or absence of a modifying and/or randomizing agent, and on the amounts of modifying and/or randomizing agent employed. The elastomers may, for example, be block, statistical, sequential or microsequential elastomers and may be prepared in dispersion or in solution; they may be coupled and/or star-branched or else functionalized with a coupling and/or star-branching or functionalization agent. Mention may be made for example, for coupling to carbon black, of functional groups comprising a C—Sn bond or aminated functional groups, such as aminobenzophenone for example; mention may be made for example, for coupling to an inorganic filler such as silica, of silanol or polysiloxane functional groups having a silanol end (such as described for example in FR 2 740 778 or U.S. Pat. No. 6,013,718 and WO 2008/141702), alkoxysilane groups (such as described for example in FR 2 765 882 or U.S. Pat. No. 5,977,238), carboxyl groups (such as described for example in WO 01/92402 or U.S. Pat. No. 6,815,473, WO 2004/096865 or US 2006/0089445) or else polyether groups (such as described for example in EP 1 127 909 or U.S. Pat. No. 6,503,973, WO 2009/000750 and WO 2009/000752). Mention may also be made, as other examples of functionalized elastomers, of elastomers (such as SBR, BR, NR or IR) of the epoxidized type.

The following are suitable: polybutadienes, in particular those having a content (mol %) of 1,2-units of between 4% and 80% or those having a content (mol %) of cis-1,4-units of greater than 80%, polyisoprenes, butadiene/styrene copolymers and in particular those having a Tg (glass transition temperature, Tg, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and especially those having an isoprene content of between 5% and 90% by weight and a Tg of −40° C. to −80° C., or isoprene/styrene copolymers and especially those having a styrene content of between 5% and 50% by weight and a Tg of between −5° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer having a Tg of between −5° C. and −70° C., are suitable in particular.

To summarize, the synthetic diene elastomer or elastomers are preferably selected from the group of highly unsaturated diene elastomers formed by polybutadienes (abbreviated to “BR”), synthetic polyisoprenes (IR), butadiene copolymers, isoprene copolymers, and blends of these elastomers. Such copolymers are more preferably selected from the group consisting of butadiene/styrene copolymers (SBR), isoprene/butadiene copolymers (BIR), isoprene/styrene copolymers (SIR) and isoprene/butadiene/styrene copolymers (SBIR).

As was specified above, liquid-phase compounding processes are preferably used to make it possible to obtain masterbatches based on diene elastomer and on carbon black that have a very good dispersion of the carbon black in the elastomer. Thus, especially for the production of the first masterbatch of diene elastomer and carbon black, use will more particularly be made of a diene elastomer latex, the elastomer latex being a particular form of the elastomer that is in the form of water-dispersed elastomer particles.

The invention therefore preferably relates to latices of diene elastomers, the diene elastomers being those defined above.

More particularly, for natural rubber (NR), this natural rubber exists in various forms as explained in detail in Chapter 3 “Latex concentrates: properties and composition” by K. F. Gaseley, A. D. T. Gordon and T. D. Pendle in “Natural Rubber Science and Technology”, A. D. Roberts, Oxford University Press-1988.

In particular, several forms of natural rubber latex are sold: the natural rubber latices referred to as “field latices”, the natural rubber latices referred to as “concentrated natural rubber latices”, epoxidized latices (ENR), deproteinized latices or else prevulcanized latices. The natural rubber field latex is a latex in which ammonia has been added to prevent premature coagulation and the concentrated natural rubber latex corresponds to a field latex that has undergone a treatment corresponding to a washing followed by a further concentration. The various categories of concentrated natural rubber latices are listed in particular according to the standard ASTM D 1076-06. Distinguished in particular from among these concentrated natural rubber latices are the concentrated natural rubber latices of quality referred to as: “HA” (high ammonia) and of quality referred to as “LA”; use will advantageously be made of concentrated natural rubber latices of HA quality.

The NR latex may be physically or chemically modified beforehand (centrifugation, enzyme treatment, chemical modifier, etc.).

The latex may be used directly or may be first diluted in water to facilitate the processing thereof.

Thus, as synthetic elastomer latex, the latex may in particular consist of a synthetic diene elastomer already available in the form of an emulsion (for example a butadiene/styrene copolymer, SBR, prepared in emulsion), or of a synthetic diene elastomer initially in solution (for example an SBR prepared in solution) which is emulsified in a mixture of organic solvent and water, generally by means of a surfactant.

An SBR latex, especially an SBR prepared in emulsion (“ESBR”) or an SBR prepared in solution (“SSBR”), and more particularly an SBR prepared in emulsion, is particularly suitable.

There are two main types of processes for the copolymerization, in emulsion, of styrene and butadiene, one of them, or the hot process (carried out at a temperature close to 50° C.), being suitable for the preparation of highly branched SBRs whereas the other, or the cold process (carried out at a temperature which may range from 15° C. to 40° C.), makes it possible to obtain more linear SBRs.

For a detailed description of the effectiveness of several emulsifiers that can be used in said hot process (as a function of the contents of said emulsifiers), reference may for example be made to the two articles by C. W. Carr, I. M. Kolthoff, E. J. Meehan, University of Minnesota, Minneapolis, Minn. which appeared in the Journal of Polymer Science of 1950, Vol. V, No. 2, pp. 201-206, and of 1951, Vol. VI, No. 1, pp. 73-81.

Regarding comparative examples of the implementation of said cold process, reference may for example be made to the article Industrial and Engineering Chemistry, 1948, Vol. 40, No. 5, pp. 932-937, E. J. Vandenberg, G. E. Hulse, Hercules Powder Company, Wilmington, Del. and to the article Industrial and Engineering Chemistry, 1954, Vol. 46, No. 5, pp. 1065-1073, J. R. Miller, H. E. Diem, B. F. Goodrich Chemical Co., Akron, Ohio.

In the case of an SBR elastomer (ESBR or SSBR), use is especially made of an SBR having an average styrene content, for example of between 20% and 35% by weight, or a high styrene content, for example from 35% to 45%, a content of vinyl bonds of the butadiene part of between 15% and 70%, a content (mol %) of trans-1,4-bonds of between 15% and 75% and a Tg of between −10° C. and −55° C.; such an SBR may advantageously be used as a blend with a BR that preferably has more than 90% (mol %) of cis-1,4-bonds.

It will be noted that it is possible to envisage using one or more natural rubber latices as a blend, one or more synthetic rubber latices as a blend, or a blend of one or more natural rubber latices with one or more synthetic rubber latices.

The polyisoprene constituting the second elastomer may advantageously be natural rubber or synthetic polyisoprene.

The synthetic polyisoprenes may have any microstructure, which depends on the polymerization conditions used, in particular on the presence or absence of a modifying and/or randomizing agent, and on the amounts of modifying and/or randomizing agent employed. These elastomers may be coupled and/or star-branched.

Synthetic polyisoprenes having a content (mol %) of cis-1,4-linkages of greater than 90%, more preferably still of greater than 95%, are particularly suitable.

Advantageously, the weight fraction of the first diene elastomer in the elastomeric matrix is greater than or equal to 50%, and preferably greater than or equal to 60%.

2) Fillers

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683, N772 or N990).

Also suitable as carbon black are the carbon blacks partially or completely covered with silica via a post-treatment, or the carbon blacks modified in situ by silica such as, non-limitingly, the fillers sold by the company Cabot Corporation under the name Ecoblack™ “CRX 2000” or “CRX4000”.

The expression “inorganic filler” should be understood here, as is known, to mean any inorganic or mineral filler, whatever its colour and its origin (natural or synthetic), also referred to as “white filler”, “clear filler” or even “non-black filler”, in contrast to carbon black, this inorganic filler being capable of reinforcing by itself alone, without means other than an intermediate coupling agent, a rubber composition intended for the manufacture of a tread for tires, in other words capable of replacing, in its reinforcing role, a conventional tire-grade carbon black for a tread. Such a filler is generally characterized by the presence of functional groups, in particular hydroxyl (—OH) groups, at its surface, requiring, in order to be used as a reinforcing filler, the use of a coupling agent or system intended to provide a stable chemical bond between the isoprene elastomer and said filler.

Such an inorganic filler may therefore be used with a coupling agent in order to enable the reinforcement of the rubber composition in which it is included. It may also be used with a covering agent (which does not provide a bond between the filler and the elastomeric matrix) in addition to a coupling agent or not (in this case the inorganic filler does not play a reinforcing role).

The physical state in which the inorganic filler is present is not important, whether it is in the form of a powder, of microbeads, of granules, of balls or any other appropriate densified form. Of course, the expression “inorganic filler” is also understood to mean mixtures of various inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as inorganic fillers. The silica used may be any silica known to those skilled in the art, especially any precipitated or pyrogenic silica having a BET surface area and a CTAB specific surface area that are both less than 450 m²/g, preferably ranging from 30 to 400 m²/g. Mention will be made, as highly dispersible precipitated silicas (“HDSs”), for example, of the Ultrasil 7000 and Ultrasil 7005 silicas from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

When the compositions are intended for tire treads having a low rolling resistance, the inorganic filler used, in particular if it is silica, preferably has a BET surface area of between 45 and 400 m²/g, more preferably of between 60 and 300 m²/g.

Preferably, the inorganic fillers for which the mean size (by weight) is between 20 and 300 nm, more preferably between 20 and 150 nm, are particularly suitable. This mean size is conventionally measured after dispersion, by ultrasonic deagglomeration, of the filler to be analysed in water or an aqueous solution containing a surfactant. For an inorganic filler such as silica, the measurement is carried out using an X-ray detection centrifugal sedimentometer of “XDC” (“X-ray disc centrifuge) type, sold by Brookhaven Instruments, according to the following procedure. A suspension of 3.2 g of sample of inorganic filler to be analysed in 40 ml of water is produced by the action over 8 minutes, at 60% power (60% of the maximum position of the “output control”), of a 1500 W ultrasonic probe (¾ inch Vibracell sonicator sold by Bioblock); after sonication, 15 ml of the suspension are introduced into the disc rotating at a speed that varies between 3000 and 6000 rpm (the speed being adapted as a function of the mean size of the filler: the smaller the size, the higher the speed); after sedimentation for 120 minutes, the weight distribution of the particle sizes and the mean size, by weight, of the particles dw are calculated by the software of the “XDC” sedimentometer (dw=S(ni di5)/S(ni di4) with ni being the number of objects of the size class or diameter di).

Preferably, the content of total filler (carbon black and inorganic filler such as silica) is between 20 and 200 phr, more preferably between 20 and 150 phr and more preferably still between 30 and 100 phr, the optimum being, as is known, different depending on the particular applications targeted: the level of reinforcement expected on a bicycle tire for example is, of course, less than that required on a tire capable of running at high speed in a sustained manner, for example a motorcycle tire, a tire for a passenger vehicle or for a utility vehicle such as a heavy vehicle.

According to one preferred embodiment, use is made of carbon black, the content of which varies from 10 to 60 phr, and an inorganic filler, in particular silica, the content of which varies from 5 to 50 phr, more particularly the total filler of the composition comprising carbon black, the content of which varies from 15 to 50 phr, and an inorganic filler, in particular silica, the content of which varies from 10 to 35 phr.

3) Masterbatches—Rubber Composition

Advantageously, the masterbatches and the compositions thus produced are capable of being used in tire applications.

The rubber compositions for tires based on masterbatches and inorganic filler may also comprise, as is known, a coupling agent and/or a covering agent and a vulcanization system.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “asymmetrical” depending on their particular structure, as described, for example, in applications WO 03/002648 (or US 2005/016651) and WO 03/002649 (or US 2005/016650).

Particularly suitable, without the definition below being limiting, are “symmetrical” silane polysulphides corresponding to the following general formula (III):

Z-A-Sₓ-A-Z , in which: (III)
x is an integer from 2 to 8 (preferably from 2 to 5);
A is a divalent hydrocarbon radical (preferably, C₁-C₁₈ alkylene groups or C₆-C₁₂ arylene groups, more particularly C₁-C₁₀, especially C₁-C₄, alkylenes, in particular propylene);
Z corresponds to one of the formulae below:

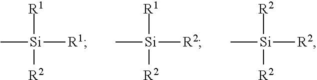

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulphides corresponding to the above formula (III), in particular the standard commercially available mixtures, the mean value of the “x” subscripts is a fractional number preferably between 2 and 5, more preferably close to 4. However, the formula may also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the aforementioned patent application WO 02/083782 (or US 2004/132880).

Mention will in particular be made, as coupling agents other than an alkoxysilane polysulphide, of bifunctional POSs (polyorganosiloxanes) or else of hydroxysilane polysulphides (R²═OH in the above formula III), such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

As covering agents, processing aids will generally be considered that are capable, as is known, owing to an improvement in the dispersion of the inorganic filler in the rubber matrix and a lowering of the viscosity of the compositions, of improving their ease of processing in the uncured state, these processing aids being for example hydrolysable silanes, such as alkylalkoxysilanes (especially alkyltriethoxysilanes), polyols, polyethers (for example polyethylene glycols), primary, secondary or tertiary amines (for example trialkanolamines), hydroxylated or hydrolysable POSs, for example a,w-dihydroxy-polyorganosiloxanes (especially a,w-dihydroxypolydimethylsiloxanes), and fatty acids such as, for example, stearic acid.

In the rubber compositions, the content of coupling agent is preferably between 0.1% and 12% by weight of the inorganic filler for a CTAB surface area of 160 m²/g, more preferably between 4% and 10% by weight of the inorganic filler for a CTAB surface area of 160 m²/g; and/or the content of covering agent is preferably between 0.1% and 20% by weight of the inorganic filler for a CTAB surface area of 160 m²/g, more preferably between 5% and 20% by weight of the inorganic filler for a CTAB surface area of 160 m²/g, it being possible for the content of coupling agent to be adjusted to the specific surface area of the filler.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

These rubber compositions may also comprise all or some of the standard additives customarily used in elastomer compositions intended for the manufacture of tires, in particular treads, such as for example plasticizers or extender oils, whether the latter are of aromatic or non-aromatic type, pigments, protective agents such as antiozone waxes, chemical antiozonants, antioxidants, anti-fatigue agents, reinforcing resins, methylene acceptors (for example, phenolic-novolac resin) or methylene donors (for example, HMT or H3M) as described, for example, in application WO 02/10269, a crosslinking system based on either sulphur or on sulphur donors, and/or on a peroxide and/or on bismaleimides, and vulcanization accelerators.

Preferably, these compositions comprise, as preferred non-aromatic or very weakly aromatic plasticizing agent, at least one compound selected from the group consisting of naphthenic oils, paraffinic oils, MES oils, TDAE oils, glycerol esters (in particular trioleates), hydrocarbon-based plasticizing resins exhibiting a high Tg preferably above 30° C., and mixtures of such compounds.

It should be noted that it is also possible to envisage producing masterbatches by incorporating therein, especially before the drying phase, additives as described above-oil, antioxidant, coupling agent, covering agent, etc.

4). Manufacture of Rubber Compositions and Masterbatches

The rubber compositions are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to one embodiment, all the base constituents of the compositions, with the exception of the vulcanization system, are incorporated intimately, by kneading, during the “non-productive” first phase, that is to say at least these various base constituents are introduced into the mixer and thermomechanically kneaded, in one or more steps, until the maximum temperature of between 130° C. and 200° C., preferably between 145° C. and 185° C., is reached.

According to one preferred embodiment, the second elastomer and the inorganic filler are incorporated into the first diene elastomer and the carbon black which have been previously prepared in the form of a first masterbatch.

Preferably, this first masterbatch is produced in the “liquid” phase. To do so, the process involves the diene elastomer in latex form, which is in the form of water-dispersed elastomer particles, and an aqueous dispersion of the carbon black, that is to say a filler dispersed in water, commonly referred to as a “slurry”. More preferably still, the steps of the process described in document U.S. Pat. No 6,048,923 will be followed, which process consists in particular in incorporating a continuous flow of a first fluid consisting of the elastomer latex into the compounding zone of a coagulation reactor, in incorporating a second continuous flow of a second fluid consisting of the aqueous dispersion of carbon black under pressure into the compounding zone to form a mixture with the elastomer latex, the compounding of these two fluids being sufficiently energetic to make it possible to almost completely coagulate the elastomer latex with the carbon black before the outlet orifice of the coagulation reactor, and then in drying the coagulum obtained.

According to another preferred embodiment, the inorganic filler and the second elastomer are incorporated into the first masterbatch by also being in the form of a second masterbatch which will have been prepared beforehand. This second masterbatch may be prepared in particular in solid form by thermomechanically kneading the second elastomer and the inorganic filler; it may also be prepared by any other process and in particular it may also be prepared in the liquid phase.

It will be noted in particular that the incorporation of the second elastomer alone and the inorganic filler alone, or in the form of a second masterbatch containing the second elastomer and the inorganic filler, may be carried out at the same time as the introduction into the mixer of the other constituents (especially the first diene elastomer or first masterbatch) but also advantageously that this or these incorporations may be offset in time by a few tens of seconds to a few minutes. In the case of introducing the second elastomer alone and the inorganic filler alone, offset in time by a few tens of seconds to a few minutes, the inorganic filler may be introduced before, after or at the same time as the second elastomer.

By way of example, the (non-productive) first phase is carried out in a single thermomechanical stage during which all the necessary constituents (where appropriate in the form of masterbatches as specified above), the optional complementary covering or processing agents and various other additives, with the exception of the vulcanization system, are introduced into an appropriate mixer, such as a standard internal mixer. The total kneading time in this non-productive phase is preferably between 1 and 15 min.

After cooling of the mixture thus obtained during the non-productive first phase, the vulcanization system is then incorporated at low temperature, generally in an external mixer such as an open mill; all the ingredients are then mixed (productive phase) for a few minutes, for example between 2 and 15 min.

The crosslinking system is preferably a vulcanization system, i.e. a system based on sulphur (or on a sulphur donor) and on a primary vulcanization accelerator. Added to this base vulcanization system are various known secondary vulcanization accelerators or vulcanization activators, such as zinc oxide, stearic acid or equivalent compounds, or guanidine derivatives (in particular diphenylguanidine), incorporated during the non-productive first phase and/or during the productive phase, as described subsequently.

The sulphur is used at a preferred content of between 0.5 and 12 phr, in particular between 1 and 10 phr. The primary vulcanization accelerator is used at a preferred content of between 0.5 and 10 phr, more preferably of between 0.5 and 5.0 phr.

Use may be made, as (primary or secondary) accelerator, of any compound capable of acting as accelerator for the vulcanization of diene elastomers in the presence of sulphur, in particular accelerators of the thiazole type, and also their derivatives, and accelerators of thiuram and zinc dithiocarbamate types. These accelerators are, for example, selected from the group consisting of 2-mercaptobenzothiazyl disulphide (abbreviated to “MBTS”), tetrabenzylthiuram disulphide (“TBZTD”), N-cyclohexyl-2-benzothiazyl sulphenamide (“CBS”), N,N-dicyclohexyl-2-benzothiazyl sulphenamide (“DCBS”), N-(tert-butyl)-2-benzothiazyl sulphenamide (“TBBS”), N-(tert-butyl)-2-benzothiazyl sulphenimide (“TBSI”), zinc dibenzyldithiocarbamate (“ZBEC”) and the mixtures of these compounds.

The final composition thus obtained is then calendered, for example in the form of a sheet or slab, especially for laboratory characterization, or else extruded in the form of a rubber profiled element that can be used for example as a tire tread for a passenger vehicle, heavy vehicle, etc.

It will be noted that such a composition may advantageously constitute the whole of the tread in.

But the rubber compositions may form only one part of a composite tread consisting for example of two radially superposed layers of different formulations (referred to as a “cap-base” structure), both intended to come into contact with the road when the tire is rolling, during the life of the latter.

The part based on compositions could then constitute the radially outer layer of the tread intended to come into contact with the ground from the moment when a new tire starts rolling, or on the contrary its radially inner layer intended to come into contact with the ground at a later stage.

### 1 PREPARATION OF MASTERBATCH OF NATURAL RUBBER AND CARBON BLACK

The first masterbatches of diene elastomer and carbon black, having a dispersion value of the filler in the elastomeric matrix of greater than or equal to 90, are produced in the liquid phase according to the process described in U.S. Pat. No. 6,048,923.

Thus, a masterbatch is prepared, according to the protocol explained in detail in the aforementioned patent, from carbon black N234 sold by Cabot Corporation, and natural rubber field latex originating from Malaysia and having a rubber solids content of 28% and an ammonia content of 0.3%.

Thus a masterbatch A of natural rubber and carbon black is obtained in which the content of carbon black is 50 phr and which has a dispersion of the black in the natural rubber matrix that has a Z value of 90.

### 2 PREPARATION OF THE RUBBER COMPOSITIONS

The various compositions were produced from the masterbatch A, to which is added, according to a conventional process of compounding in solid form, a second elastomer and precipitated silica (Ultrasil 7000 sold by Evonik).

The various compositions are produced in the following manner:

The tests below are carried out in the following manner: introduced into an internal mixer, filled to 70%, and the initial vessel temperature of which is around 60° C., are the first masterbatch A, a second, identical or different, elastomer, precipitated silica (Ultrasil 7000), a coupling agent and then, after kneading for one to two minutes, the various other additives, with the exception of the vulcanization system.

Thermomechanical working (non-productive phase) is then carried out in one stage (total duration of the kneading equal to around 5 min), until a maximum “dropping” temperature of around 165° C. is reached.

The mixture thus obtained is recovered and cooled and then the vulcanization system (sulphur and a sulphenamide accelerator) is added to an external mixer at 70° C., by compounding the combined mixture (productive phase) for around 5 to 6 min.

The compositions thus obtained are then calendered either in the form of slabs (thickness of 2 to 3 mm) or thin sheets of rubber for the measurement of their physical or mechanical properties, or in the form of profiled elements that can be used directly, after cutting and/or assembly to the desired dimensions, for example as semi-finished products for tires, in particular as tire treads.

### 3 EXAMPLE

The purpose of this example is to demonstrate the properties of a rubber composition in accordance with embodiments of the invention based on a blend of carbon black and silica, and natural rubber and synthetic polyisoprene, which properties are improved relative to control compositions based on the same blend of reinforcing filler but having a different elastomeric matrix.

The compositions C1 and C2 not in accordance with the invention are respectively prepared from a first masterbatch A, to which are added, in solid form, a second elastomer, respectively a styrene/butadiene copolymer (SBR) and a polybutadiene (BR), and also silica, according to the process described in detail in section III-2.

The composition C3 in accordance with the invention is also prepared from a first masterbatch A, to which are added, in solid form, a second elastomer, synthetic polyisoprene (IR), and also silica, according to the process described in detail in section III-2.

All of the compositions have the following basic formulation (in phr):
natural rubber 80
second elastomer 20
carbon black (a) 40
silica (b) 15
6PPD (c) 2
silane (e) 1.5
stearic acid 2
zinc oxide (f) 2.7
accelerator (g) 0.75
sulphur 1.6
   (a) N234 sold by Cabot Corporation;
   (b) Ultrasil 7000 sold by Evonik;
   (c) N-1,3-dimethylbutyl-N-phenyl-para-phenylenediamine (“Santoflex 6-PPD” from Flexsys);
   (d) MES oil (“Catenex SNR” from Shell);
   (e) TESPT (“SI69” from Evonik);
   (f) zinc oxide (industrial grade—Umicore);
   (g) N-cyclohexyl-2-benzothiazyl sulphenamide (“Santocure CBS” from Flexsys).

The compositions C1, C2 and C3 differ from one another due to the nature of the second elastomer, as described in detail in the summary table, Table 1, below:

TABLE 1

| | Composition | | |
|---|---|---|---|
| | C1 | C2 | C3 |
| SBR (1) | 20 | — | — |
| BR (2) | — | 20 | — |
| IR (3) | — | — | 20 |

(1) Unextended, tin-functionalized SBR solution with 24% of 1,2-polybutadiene units and 26.5% of styrene, Tg = −48° C.;
(2) BR (Nd with 0.7% of 1,2- units; 1.7% of trans-1,4- units; 98% of cis-1,4- units (Tg = −105° C.);
(3) IR with 0.5% of cis-3,4- units; 0.9% of trans-1,4- units; 98.6% of cis-1,4- units (Tg = −65° C.) sold under the name “IR6596” byNizhnekamsk.

The properties measured after curing at 150° C. for 40 minutes are given in Table 2 below.

TABLE 2

| Properties after | Composition | | |
|---|---|---|---|
| curing | C1 | C2 | C3 |
| Average tearability | 59 | 61 | 72 |
| force (N/mm) | | | |
| Strain at break | 636 | 668 | 678 |
| Stress at break | 24.3 | 24.4 | 26.0 |
| Tan(δ)max | 0.148 | 0.146 | 0.142 |

The comparison between these three compositions shows that all three have properties at break (strain and stress) and also a hysteresis that are quite similar (even somewhat improved for each property for the composition C3 in accordance with the invention).

But it is very surprisingly observed that the composition in accordance with the invention C3 that includes polyisoprene as second elastomer, has tearability properties far greater than those exhibited by the two other compositions that include respectively SBR and BR as the second elastomer.

Yet there was nothing to suggest that the presence of IR could make it possible to obtain such properties, especially as, in terms of glass transition temperature, this elastomer has a Tg intermediate between BR and SBR.

1. A rubber composition based on at least one first diene elastomer, a reinforcing filler comprising at least carbon black and an inorganic filler with an inorganic filler content of less than or equal to 50 parts by weight per hundred parts of elastomer, wherein the composition is obtained from a first masterbatch comprising at least the first diene elastomer and carbon black, and having a dispersion of the carbon black in the elastomeric matrix that has a Z value of greater than or equal to 90, added to which is the inorganic filler and at least one second elastomer consisting of a polyisoprene.

2. The composition according to claim 1, in which the first masterbatch is obtained by liquid-phase compounding starting from a latex of the first diene elastomer and an aqueous dispersion of carbon black.

3. The composition according to claim 2, in which the first masterbatch is obtained according to the following process steps:
feeding a continuous flow of the latex of the diene elastomer to a mixing zone of a coagulation reactor defining an elongate coagulation zone extending between the mixing zone and an outlet,
feeding a continuous flow of a fluid comprising a filler under pressure to the mixing zone of a coagulation reactor to form a coagulated mixture,
drying the coagulum obtained above in order to recover the first masterbatch.

4. The composition according to claim 1, in which the weight fraction of the first diene elastomer in the elastomeric matrix is greater than or equal to 60%.

5. The composition according to claim 4, in which the weight fraction of the first diene elastomer in the elastomeric matrix is greater than or equal to 80%.

6. The composition according to claim 1, in which the first diene elastomer is selected from the group consisting of polybutadienes, natural rubber, synthetic polyisoprenes, butadiene copolymers, isoprene copolymers and blends of these elastomers.

7. The composition according to claim 6, in which the first diene elastomer is a natural rubber.

8. The composition according to claim 1, in which the inorganic filler is a silica or a silica-covered carbon black.

9. The composition according to claim 8, in which the inorganic filler is a precipitated silica.

10. The composition according to claim 1, in which the content of all of the reinforcing filler is between 20 and 150 phr.

11. The composition according to claim 10, in which the content of carbon black is between 10 and 60 phr, and the content of inorganic filler is between 5 and 50 phr.

12. A process for obtaining a composition based on at least one first diene elastomer and a second elastomer consisting of a polyisoprene, a reinforcing filler comprising at least carbon black and an inorganic filler with an inorganic filler content of less than or equal to 50 parts by weight per hundred parts of elastomer, which comprises the following steps:
preparing a first masterbatch comprising the diene elastomer and the carbon black, this first masterbatch having a dispersion of the reinforcing filler in the elastomeric matrix that has a Z value greater than or equal to 90,
incorporating the inorganic filler, the second elastomer and the other constituents of the composition, with the exception of the crosslinking system, into the first masterbatch in a mixer, everything being kneaded thermomechanically until a maximum temperature of between 130° C. and 200° C. is reached,
cooling the combined mixture to a temperature below 100° C.,
subsequently incorporating: the crosslinking system,
kneading everything up to a maximum temperature below 120° C.

13. The process according to claim 12, in which the inorganic filler and the second elastomer are introduced simultaneously.

14. The process according to claim 12, in which the inorganic filler and the second elastomer are introduced in the form of a pre-prepared second masterbatch.

15. The process according to claim 12, in which the inorganic filler and the second elastomer are introduced separately; the inorganic filler being introduced before or after the second elastomer.

16. The process according to claim 12, in which the introduction of the inorganic filler and/or of the second elastomer is offset in time by a few tens of seconds to a few minutes relative to the introduction of the first masterbatch into the mixer.

17. The process according to claim 12, in which the first masterbatch is produced in the liquid phase from at least one latex of the first diene elastomer and a dispersion of carbon black.

18. The process according to claim 17, in which the first masterbatch is produced according to the following successive steps:
feeding a continuous flow of the first diene elastomer latex to a mixing zone of a coagulation reactor defining an elongate coagulation zone extending between the mixing zone and an outlet orifice,
feeding a continuous flow of a fluid comprising a filler under pressure to the mixing zone of a coagulation reactor to form a coagulated mixture,
drying the coagulum obtained above in order to recover the first masterbatch.

19. The process according to claim 12, in which the inorganic filler is a silica, or a silica-covered carbon black.

20. The process according to claim 12, in which the first diene elastomer consists of a natural rubber.

21. A finished or semi-finished article comprising a composition according to claim 1.

22. A tire tread comprising a composition according to claim 1.

23. A tire or semi-finished product comprising at least one composition according to claim 1.
